(19) United States
(12) Patent Application Publication
(10) Pub. No.: US 2004/0075829 A1
(43) Pub. Date: Apr. 22, 2004

(54) Roundness standard

(76) Inventors: Kostadin Doytchinov, Gloucester (CA); Jim Pekelsky, Ottawa (CA); Lorne Munro, Ottawa Ontario (CA)

Correspondence Address: Marks & Clerk, Station B, PO Box 957, Ottawa, ON, K1P 5S7, CA

(21) Appl. No.: 10/182,795

(22) PCT Filed: Feb. 1, 2001
(86) PCT No.: PCT/CA01/00119

(51) Int. Cl. G01J 1/10

(52) U.S. Cl. 356/243.1

(57) ABSTRACT

A roundness calibration device includes a ring or plug gauge with a wall defining an arcuate surface traversable by a sensing probe. A protuberance, typically in the form of a piston, is displaceably mounted in a radial bore in the wall. A displacement device adjusts the amount of protrusion of said protuberance to locally, radially modify the arcuate surface. A calibrated measuring device accurately determines the amount of protrusion.

### CROSS REFERENCE TO RELATED APPLICATION

This application claims the benefit under 35 USC 119(e) of U.S. Provisional application No. 60/180,204 filed Feb. 4, 2000.

### BACKGROUND OF THE INVENTION

1. Field of the Invention

This invention relates to the measurement of the roundness of arcuate surfaces, both internal and external, and in particular to a method and device for improving the quality and traceability of roundness measurements.

2. Brief Description of the Prior Art

There are two fundamental designs of roundness measuring machines. One has a rotating table on which the test piece rests and is rotated while in contact with a stationary displacement probe; the other has a displacement probe carried on the end of a rotating spindle traversing the perimeter of the stationary test piece. The variation of the radial distance of the surface from the rotational axis is transmitted as an electrical signal to an amplifier, then converted to length units and recorded to a file. This raw data is subsequently subjected to different mathematical operations, such as filtering and best-fitting, according to a selected mathematical criterion. Normally several magnification scales are available depending on the range of the radial deviations recorded by the probe.

Roundness measuring instruments have to be routinely calibrated for the displacement scale-factor of their electronic probes. For several decades, this has been done by using precisely machined external cylindrical standards, known as flick standards (also magnification standards). These standards consist of a cylindrical body with a very small, narrow, flat surface extending the length of the cylinder. During a roundness scan, the sensing probe traverses (flicks across) the flat region and forces a stylus to undergo a rapid radial change, or a “flick”. The measured deviation is the maximum depth of the flick from the calculated best-fit circle to the rest of the cylindrical surface. The flick portion is excluded during the best-fitting of the circle but included when calculating the maximum deviation. This maximum deviation is then compared to the known calibration value of the flick depth and a linear scale-factor correction for the sensing probe is derived. The calibrated radial profile of the cylinder is used to calibrate the probe deflection scale. Gauges of different depths of flat regions allow probe calibration at different scale magnifications; hence these gauges are also called “magnification standards” by roundness metrologists.

These external-cylinder flick standards have several limitations. They are very difficult to calibrate traceable to national standards of length; they are not suitable for high accuracy calibration of roundness instruments to be used for internal roundness measurements; more than one standard is required in order to cover different magnifications; the calibration, which relies on a single value, can only be a linear compensation of the scale-factor function; and measurements of internal cylindrical surfaces with a probe calibrated on an external cylindrical surface are not strictly traceable to national standards of length.

Non-linearity of the scale cannot be revealed by the flick method. Flick standards are typically calibrated using 1-D comparator methods and have a typical uncertainty of calibration of 1 μm (95% confidence level) on a step of 20 μm. They are available only as external cylinders. This constitutes a problem when measuring roundness on internal surfaces, because the probe is working in a mode different from the one used during the calibration and therefore any external-mode measurements are not traceable to those made during the calibration. Metrologists consider this to be a fatal flaw (broken traceability) of the flick method regarding roundness metrology.

For traceable probe calibration for internal measurements, static-mode calibration methods can be also used. The principle behind this method is that in a non-rotating or static mode the probe is in stationary contact with a jig that makes only a linear deflection in the radial direction. By activating the jig, the probe is deflected by a known amount (for example, directly measured by a laser interferometer incorporated in the jig), the results are compared and a probe scale calibration function derived. The drawback of this method is that the static-mode calibration does not account for the dynamic rotational effects arising during actual use of the instrument.

GB patent no. 2,199,663 describes a set of standard gauges that have a protuberance projecting from an arcuate surface. In one embodiment the protuberance can be adjusted in the radial direction by means of an insert and gauge block. This arrangement does not permit the calibration to take place effectively without disturbing or interrupting the metrology set-up.

### SUMMARY OF THE INVENTION

The invention relates to a new roundness calibration device with an internal or external cylindrical reference surface that can be radially modified in a small region of the circumference.

Accordingly, the present invention provides a roundness calibration device for use in metrology, comprising a ring gauge having a wall defining an arcuate surface traversable by a sensing probe, and a protuberance displaceably mounted in a radial bore in said wall for locally modifying said arcuate surface to create a local bump, characterized in that a displacement device is provided for moving said protuberance within said bore to adjust its relative position during a calibration procedure, and a measuring device is provided for accurately determining the relative displacement of said protuberance during said calibration procedure.

The protuberance is preferably a piston that may be displaced by a piezo-electric or electromagnetic or micrometer screw gauge block actuator. The protrusion displacement can be measured, for example by a micrometer or an interferometer detecting a laser beam reflected off an interferometer optic (such as a plan mirror, or a retroreflector prism, or even a polished end of the piston) that moves with the proximal end of the piston. Alternatively, the protuberance can be a pusher that deforms a membrane or a thin shell defining the arcuate surface, which is typically an internal surface, but may also be an external surface.

It will be appreciated that in order to calibrate the probe it is not necessary to know the absolute position of the protuberance, but merely the relative displacement between the extended and retracted positions. Typically, measurements are taken with the protuberance in two positions with the distance between them being precisely known.

The amount of the radial deflection at the local bump in the surface can be controlled, and a radial bump height difference between two piston positions used to calibrate the probe of roundness measuring instruments.

There are several advantages to such a calibration device. The calibration characterizes the probe in its dynamic mode of operation, in the same way that regular in-use roundness measurements are performed; the concept is applicable to both internal and external cylindrical surfaces; the generated radial bump height is variable, which allows for the creation of probe compensation functions of higher order; the generated radial bump height difference can easily be made traceable to national standards of length; and by changing the piston profiles, the instruments can also be tested for different characteristics. For example, by using different slopes on the piston, the devices can be used for evaluation of the dynamic response of the probe.

In a further aspect the invention provides a method of calibrating a roundness measuring device having a sensing probe, comprising mounting a protuberance in a radial bore formed in a wall of a ring gauge defining an arcuate surface, and adjusting said protuberance so that it creates a local bump in said arcuate surface, characterized in that during a calibration procedure the relative position of said protuberance is changed, the relative displacement of said protuberance is precisely measured, and said sensing probe is moved over said arcuate surface with said protuberance protruding by different amounts to determine the displacement of said sensing probe as said sensing probe moves over said local bump thereby to calibrate said roundness measuring device.

### BRIEF DESCRIPTION OF THE DRAWINGS

The invention will now be described in more detail, by way of example only, with reference to the accompanying drawings, in which:

FIGS. 1aand 1b are schematic views, in cross section, of a ring gauge with the piston in different positions;

FIGS. 2a and 2b are longitudinal sectional views showing piston crown profiles;

FIG. 3 shows one practical embodiment of the invention;

FIGS. 4a and 4b show one embodiment of a manual adjustment device; and

FIGS. 5a and 5b shows further embodiments of the ring gauge.

### DETAILED DESCRIPTION OF THE INVENTION

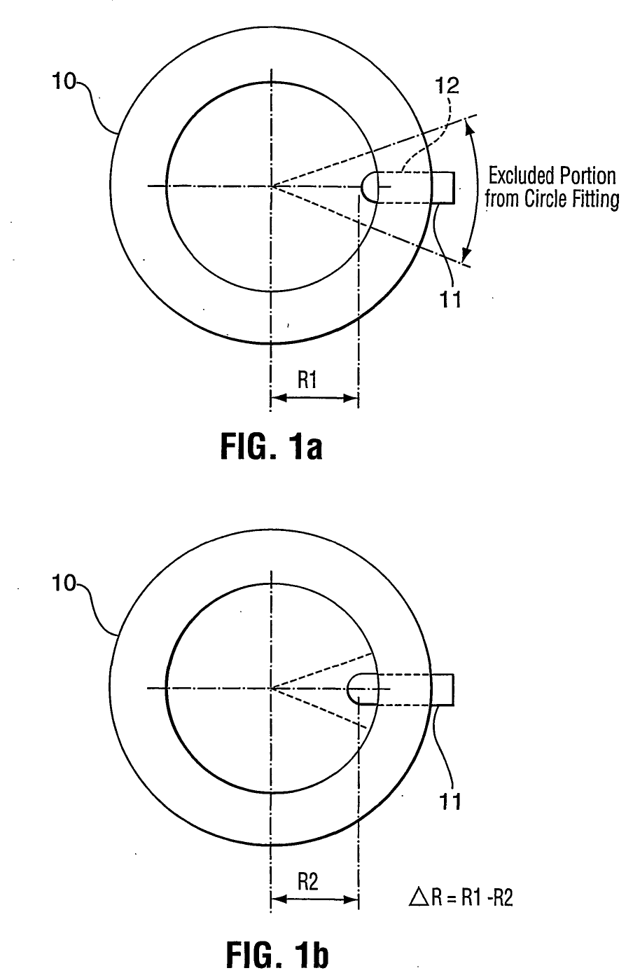

As shown in FIGS. 1a and 1b, the device in accordance with the preferred embodiment is a ring gauge 10 made of suitably hard material with a stable geometry, such as gauge-grade steel, with a movable piston 11 installed in a bore 12 formed in the radial direction to the axis of the cylindrical surface to be measured for roundness. The piston 11 is used to generate a known step or simply provide a known difference size of “bumps” on the roundness profile between two scans. A “bump” is a convex or concave disturbance of the roundness profile created by the piston 11 or by a pusher deforming a membrane or thin shell. The piston 11 can be moved manually (such as by a micrometer screw), or driven by an actuator (such as a piezo-drive). During the procedure a minimum of two roundness measurements with different piston positions are performed. One scan is taken before moving the piston, and one taken after, to produce the desired height difference, or step. To better explore the calibration range, it is recommended that measurements be performed on more that two of these created steps. The datum for the measurements is the center of the best-fit circle to the cylindrical surface with the protrusion portion excluded.

FIG. 1a shows piston 11 in the retracted position and FIG. 1b shows it in the extended position. The distance to the axis of the ring is shown as R1 and R2 respectively, so the distance between these two positions, ΔR, is given by the expression:

ΔR=R1−R2

The typically high number of sample points measured during a roundness profile scan provides a very good characterization of the datum profile. The height difference can be determined based on a Max(Min) point (single point evaluation) or based on a multi-point evaluation section of the piston crown. The measured height difference is then compared with the calibrated height difference value (directly measured or previously calibrated). The proportion of the measured and generated distances is used to derive the scale calibration function of the probe. The crown surface of the piston could be cylindrical or spherical, concave or convex.

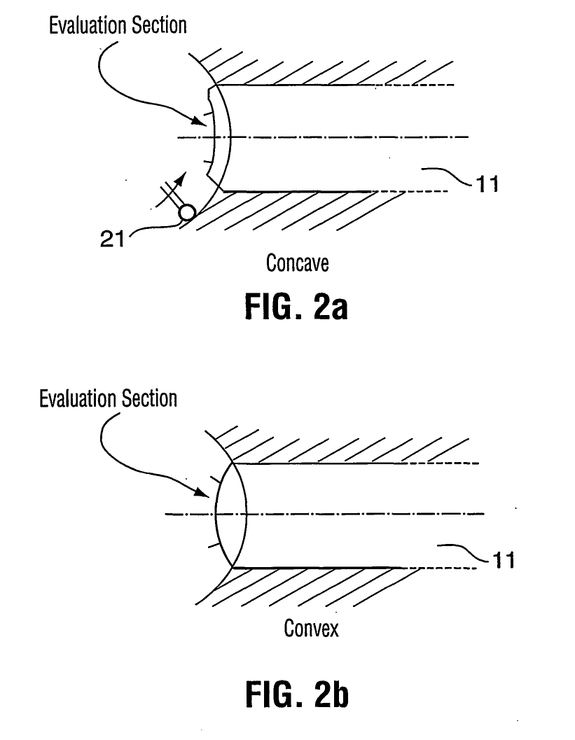

In FIGS. 2a and 2b, two possible examples of piston crown profiles are shown. The size of the radius of the concave type (FIG. 2a) is the same as the radius of the-cylinder surface of the device. This assures that after “climbing” onto the piston crown, and the initial “settling down”, the gradient of the radius change sensed by the probe 21 is negligible and provides a very good constant-radius evaluation section. By selecting piston crown profiles with different slopes to provoke different gradients, the device can also be used to test the dynamic response of the instrument at different measurement speeds. This gives information about the response of the device to rapid changes and various different shapes of deformation. Such information can be used to select an optimum measurement speed or allow a better estimate of the uncertainty of measurements.

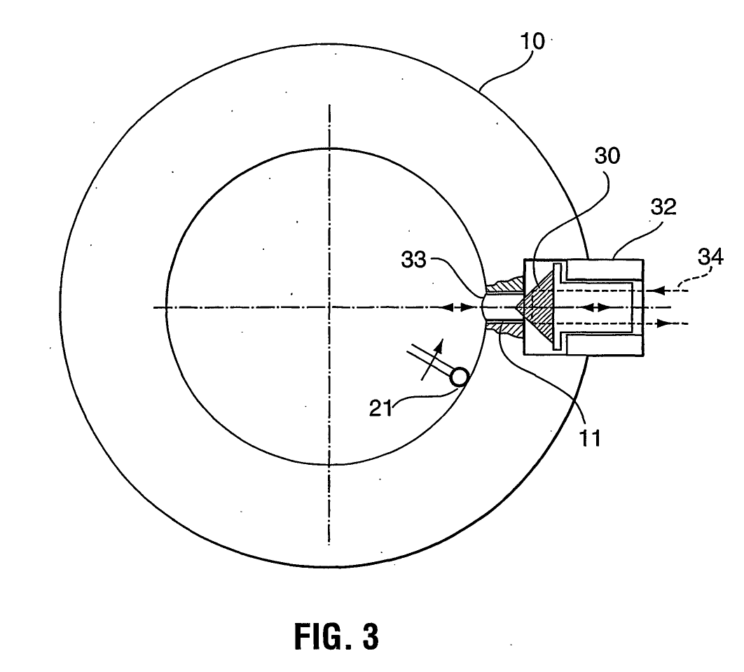

A practical embodiment of the invention is shown in FIG. 3. Serving as an interferometer optic, a retroreflector 30 with an attached piston 11 is mounted inside the hollow piezo-electric drive 32. Other interferometer optics, such as a plain mirror, are also possible. The application of a voltage to the piezo-drive 32 causes the attached piston 11 to disturb the roundness profile by generating a bump 33. The retroreflector 30 moves with the piston 11.

A laser beam 34 is reflected by the retroreflector 30 and the height difference between two bumps is directly measured by an interferometer with an uncertainty much lower than the flick depth can be measured for the traditional magnification standards. The high resolution and accuracy (10 nm or smaller, typically) of an interferometric system permits calibration of the highest magnifications of roundness instruments to a very low uncertainty.

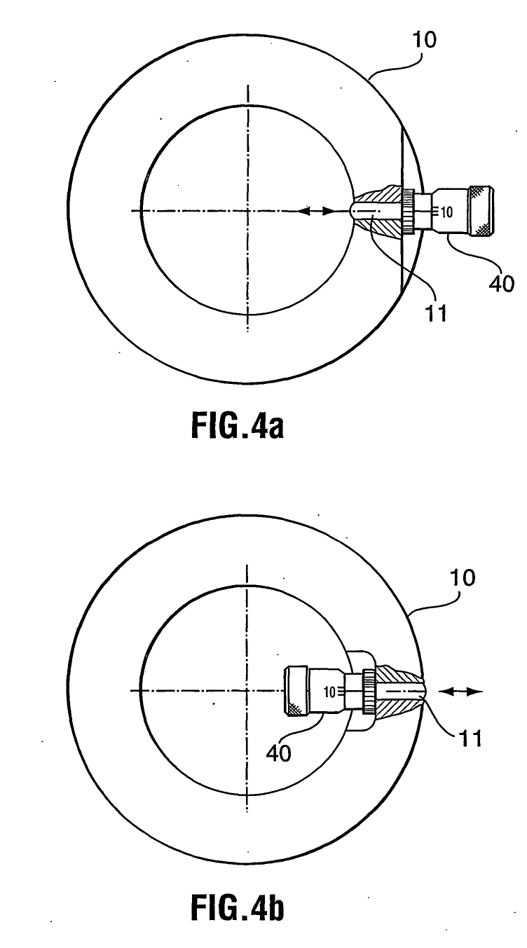

FIGS. 4a and 4b show an example of a manual-adjustment solution. The piston 11 is now the spindle of a differential micrometer. The setability of such a micrometer can be in the range of 50 nm and its positioning accuracy can be calibrated to an uncertainty (1μm) which is comparable with the uncertainty of traditional flick standards while adding the advantage of internal measurements traceable to national standards and the variable generated height difference.

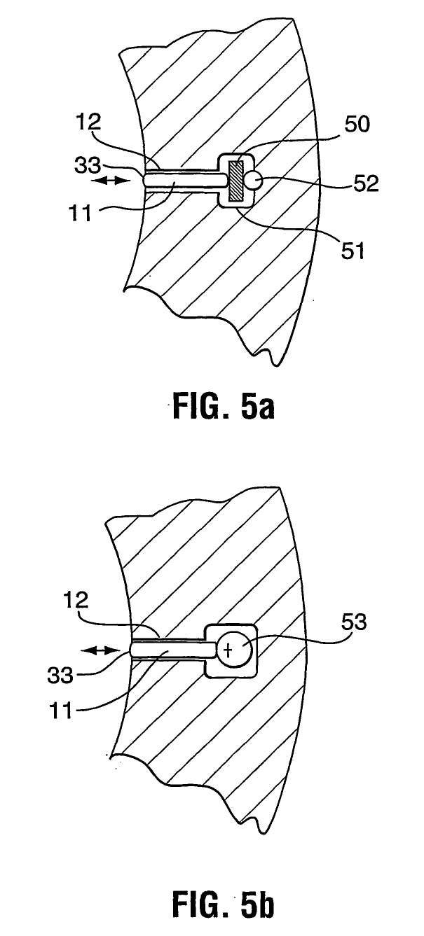

FIG. 5a shows a further embodiment wherein the piston 11 abuts at its innermost end against a gauge block 50 located in cavity 51. The rear face of the gauge block 51 abuts a ball bearing 52. A recess is provided in the external surface of the ring gauge to permit insertion of the gauge block.

A gauge block is a block of material with a precisely calibrated thickness. Such a block can be calibrated off line to national standards of length. After making one measurement with the probe, the gauge block is removed and replaced by a second block of different thickness. In each case, the back end of the piston is held against the gauge block so that the difference between the thicknesses of the two blocks determines the degree of movement of the piston between its two positions. The advantage of the gauge block is that it is very common dimensional standard, and as such is routinely calibrated traceable to national standards to a very small uncertainty. Gauge blocks are widely used in industry, and have evolved to be the most precise material standards available at any price.

An alternative method is shown in FIG. 5b. This arrangement is similar to that shown in FIG. 5a except that the gauge block is replaced by an eccentrically mounted cam 53. The cam 53 can be rotated by a conventional mechanism with a detent (not shown) between first and second positions, such that the displacement of the piston 11 by the cam depends on the difference in radius at the two positions. Like the gauge block, the cam displacement can also be calibrated to national standards off line.

It will be appreciated that other means of displacement and measuring device can be employed. For example, an LVDT (Linear Voltage Displacement Transducer) can be used to move the piston. Piezo-electric or electromagnetic actuators can be separately calibrated so that they could serve directly as the displacement measuring device.

The movable piston can also be applied to an external cylindrical surface, which will make the same calibration standard suitable for different external-mode magnification ranges.

1. A roundness calibration device for use in metrology, comprising a ring gauge having a wall defining an arcuate surface traversable by a sensing probe, and a protuberance displaceably mounted in a radial bore in said wall for locally modifying said arcuate surface to create a local bump, a displacement device for moving said protuberance within said bore to adjust its relative position during a calibration procedure, and a measuring device for accurately determining the relative displacement of said protuberance during said calibration procedure.

2. A roundness calibration device as claimed in claim 1, wherein said protuberance is a piston that protrudes beyond said arcuate surface.

3. A roundness calibration device as claimed in claim 2, wherein said piston has a concave end.

4. A roundness calibration device as claimed in claim 3, wherein said concave end has a radius of curvature equal to the radius of curvature of said arcuate surface.

5. A roundness calibration device as claimed in claim 2, wherein said piston has a convex end.

6. A roundness calibration device as claimed in claim 1, wherein said arcuate surface is defined by a shell or membrane, and said protuberance is a pusher that locally displaces said shell or membrane.

7. A roundness calibration device as claimed in claim 1, wherein said device for adjusting the relative position of the protuberance is a mechanical adjuster including a micrometer serving as said measuring device.

8. A roundness calibration device as claimed in claim 1, wherein said device for adjusting the relative position of the protuberance is a piezo-electric actuator.

9. A roundness calibration device as claimed in claim 1, wherein said device for adjusting the relative position of the protuberance is an electromagnetic actuator.

10. A roundness calibration device as claimed in claim 8, wherein an interferometer optic is linked to a proximal end of said protuberance, and said measuring device comprises an interferometer.

11. A roundness calibration device as claimed in claim 10, wherein said interferometer optic is a retroreflector.

12. A roundness calibration device as claimed in claim 10, wherein said interferometer optic is a plain mirror.

13. A roundness calibration device as claimed in claim 1, wherein said arcuate surface is an external surface of said ring gauge.

14. A roundness calibration device as claimed in claim 1, wherein said arcuate surface is an internal surface of said ring gauge.

15. A roundness calibration device as claimed in claim 1, wherein said device for adjusting the relative displacement of the protuberance is a cam which also serves as said measuring device.

16. A roundness calibration device as claimed in claim 1, wherein said device for measuring the relative position of the protuberance is a linear voltage displacement transducer.

17. A method of calibrating a roundness measuring device having a sensing probe, comprising mounting a protuberance in a radial bore formed in a wall of a ring gauge defining an arcuate surface, adjusting said protuberance so that it creates a local bump in said arcuate surface, changing the relative position of said protuberance during a calibration procedure, precisely measuring the relative displacement of said protuberance, and moving said sensing probe over said arcuate surface with said protuberance protruding by different amounts to determine the displacement of said sensing probe as said sensing probe moves over said local bump thereby to calibrate said roundness measuring device.

18. A method as claimed in claim 17, wherein the position of said protuberance is set with a mechanical adjuster, and the relative position is measured with a micrometer forming part of said mechanical adjuster.

19. A method as claimed in claim 17, wherein said protuberance is displaced with a piezo-electric actuator.

20. A method as claimed in claim 17, wherein said protuberance is displaced with an electromagnetic actuator.

21. A method as claimed in claim 17, wherein an interferometer optic is disposed so as to move with a proximal end of said protuberance, and the degree of protrusion is measured with an interferometer.

22. A method as claimed in claim 21, wherein said interferometer optic is selected from the group consisting of a retroreflector and a plain mirror.

23. A method as claimed in claim 17, wherein said arcuate surface is an external surface.

24. A method as claimed in claim 17, wherein said arcuate surface is an internal surface of said ring gauge.

25. A method as claimed in claim 17, wherein said protuberance is a pusher that deforms a membrane or shell forming said arcuate surface.

26. A method as claimed in claim 17, wherein said probe is moved over said surface with said protuberance in at least two positions, and the measured distance between said positions is used to calibrate the roundness measurement device.

27. A method as claimed in claim 17, wherein a cam is in abutting relationship with a proximal end of said protuberance, said cam having first and second positions determining different pre-calibrated amounts of protrusion of said protuberance, and said sensing probe is moved over said arcuate surface with said cam in both said first and second positions, the difference-between the two positions of said protuberance corresponding to the first and second positions of the cam being used to calibrate said roundness measuring device.
